(19) United States
(12) Patent Application Publication
(10) Pub. No.: US 2025/0291812 A1
(43) Pub. Date: Sep. 18, 2025

(54) INTEGRATION DEVICE, INTEGRATION METHOD, AND RECORDING MEDIUM

(71) Applicant: Hitachi, Ltd., Tokyo (JP)

(72) Inventors: Norifumi NISHIKAWA, Tokyo (JP); Kazuhiko MOGI, Tokyo (JP); Shinji FUJIWARA, Tokyo (JP); Mika TAKATA, Tokyo (JP)

(21) Appl. No.: 18/882,685

(22) Filed: Sep. 11, 2024

(30) Foreign Application Priority Data
Mar. 14, 2024 (JP) 2024-040192

(51) Int. Cl. G06F 16/25; G06F 16/22; G06F 16/242

(52) U.S. Cl. CPC G06F 16/256; G06F 16/2282; G06F 16/2423

(57) ABSTRACT

An integration device is configured to execute: mount processing in which a virtual volume is created for each database and mounted to the storage location information; first generation processing in which, from the first table of each of the plurality of devices, the DB name and the storage location information are acquired, second generation processing in which, from the second table of each of the plurality of devices, the schema name, the table name, and the DB area ID are acquired, and third generation processing in which, from the third table of each of the plurality of devices, the DB area ID and the relative file path of the file are acquired, and a third integrated table is generated by associating the changed-to DB name, the DB area ID, and the relative file path with one another for each database.

### CROSS-REFERENCE TO RELATED APPLICATION

The present application claims priority from Japanese patent application No. 2024-40192 filed on Mar. 14, 2024, the content of which is hereby incorporated by reference into this application.

### BACKGROUND OF THE INVENTION

This invention relates to an integration device, an integration method, and a recording medium by which databases are integrated.

WO 2011/049839 A1 discloses that information from multiple databases is retrieved and stored on a database storage system. Multiple point-in-time copies are obtained for each database. A point-in-time copy retrieves data changed in the database since the retrieval of a previous point-in-time copy. A virtual database (VDB) is created by creating a set of files in the data storage system. Each file in the set of files created for a VDB is linked to the database blocks on the database storage system associated with a point-in-time copy of the source database. The set of files associated with the VDB are mounted on a database server allowing the database server to read from and write to the set of files. Workflows based on VDBs allow various usage scenarios based on databases to be implemented efficiently, for example, testing and development, backup and recovery, and data warehouse building.

U.S. Pat. No. 11,561,976 B1 discloses that techniques and solutions are described for storing and processing metadata, including to instantiate database artefacts at a target system based on metadata for database artefacts maintained at a source system. The target system can query the source system for metadata associated with database artefacts of the source system. The target system can instantiate database artefacts based on such metadata. The database artefacts of the target system are linked to corresponding database artefacts of the source system, such as by associating a database artefact of the target system with an API useable to obtain data or metadata from the source system for a corresponding database artefact of the source system. The target system obtains additional data or metadata for a database artefact of the target system using a corresponding API.

U.S. Pat. No. 5,852,715 A discloses a method of implementing decision support in an environment including a data storage system and a plurality of host processors at least some of which are connected to the data storage system, wherein the data storage system stores a working database, the method including the steps of through a selected one of the plurality of host processors, updating the working database on an ongoing basis; while the working database is being updated on an ongoing basis, generating a copy of the working database; using the copy of the database to generate a support copy of the database; and through a different one of the plurality of host processors, using the support copy for the purpose of implementing decision support functions.

U.S. Pat. No. 7,925,680 B1 discloses a system and method for processing a plurality of data storage and retrieval management or manifest files in a virtual data storage system. A plurality of individual management/manifest files, which are each used to track data management information stored on a data storage device, are merged into a single management or manifest file that can then be used to subsequently manage the input or import of data such as logical volumes from one or more physical media. This single management/manifest file could be used, for example, in a media import operation for importing a media cartridge or device into a media library such as a data storage library.

U.S. Pat. No. 7,933,921 B discloses that when receiving a client data access request directed to a first data container serviced by a first federation member, data of the first requested data container may be used to resolve a context identifier and identify a volume location database (VLDB) associated with a second federation member servicing a second data container. A look up request may then be sent to the VLDB to identify one or more locations of the second data container. The client's original data access request illustratively may then be responded to with the identified one or more locations of the second data container.

JP 2004-295811 A discloses that each of a DBMS server device, a virtual switch device and a storage device holds partial information of data mapping information, starting from a specific DB table accessed by the job, to a physical disk device for distributing and storing data on a volume via a logical volume storing the table. A management server device acquires the partial information from each device and collects the data mapping information for every job. When the trouble occurs to any device or mechanism on a data mapping path, the jobs influenced by the trouble are specified referring to the data mapping information. The management server device 1000 controls the execution of these jobs.

JP 2015-146201 A discloses a method includes: retrieving data from a multi-tenant database system having a relational data store and a non-relational data store; receiving a request specifying data to be retrieved from the multi-tenant database system; retrieving one or more locations of the data to be retrieved on the basis of the request; generating a database query specifying a plurality of data elements to be retrieved on the basis of the request; the plurality of data elements including one or more data elements residing within the non-relational data store and one or more other data elements residing within the relational data store; and executing the database query against the multi-tenant database system to retrieve the data.

In Dremio Architecture Guide (https://community.denodo.com/docs/html/browse/8.0/jp/vdp/administration/general_a rchitecture/general_architecture, retrieved on Feb. 21, 2024), Denodo Virtual DataPort is disclosed. Denodo Virtual DataPort is a mediation function that provides a structured and unified view of data contained in all data sources included in a system, and includes a three-layer architecture made up of a physical layer (wrappers), a logical layer, and a user layer.

In Dremio Architecture Guide (https://community.denodo.com/docs/html/browse/8.0/jp/vdp/administration/general_a rchitecture/physical_layer/physical_layer, retrieved on Feb. 21, 2024), the physical layer is disclosed. The physical layer is wrappers for various types of data sources, and is designed to extract data (including metadata) from a source, convert the data into a format of the Virtual DataPort, and return a result thereof to the user layer.

In Dremio Architecture Guide (https://community.denodo.com/docs/html/browse/8.0/jp/vdp/administration/general_a rchitecture/logical_layer/logical_layer, retrieved on Feb. 21, 2024), the logical layer is disclosed. The logical layer corresponds to a federation function of a DBMS. Metadata acquired through the physical layer is managed by the logical layer. The logical layer is also capable of push-down of a process, and has a function of caching data as well.

In Dremio Architecture Guide (https://community.denodo.com/docs/html/browse/8.0/jp/vdp/administration/general_a rchitecture/user_layer/user_layer, retrieved on Feb. 21, 2024), the user layer is disclosed. The user layer is an interface between client applications and the Virtual DataPort.

In Dremio Architecture Guide (DremioArchitectureGuide.pdf, retrieved on Feb. 21, 2024), a transparent query function for files in cloud storage and data in DBMSs (SQL and NoSQL) is disclosed. In a case of a data source that is a file in cloud storage, Dremio executes data conversion so that data can be accessed from a client in a uniform format. In a case of a data source that is a DBMS, the data source side executes a query and acquires data, and Dremio subsequently executes data conversion so that the data can be accessed from a client in a uniform format.

With the technology of WO 2011/049839 A1, integration of databases involves collection and integration of data via the database server of a business operation database system and, due to a resultant increased load on the database server, a drop in performance of the business operation database system is a concern.

The technology of U.S. Pat. No. 11,561,976 B1 requires a framework for extraction and conversion of metadata on the source system side, and requires modification on the source system side. A CPU load of the source system also increases because metadata and data are required to be acquired on the source system.

In U.S. Pat. No. 5,852,715 A, copying of a database volume by storage is disclosed but integration of volumes is not disclosed.

The technology of Dremio Architecture Guide requires a data conversion process in the physical layer, and consequently causes a drop in performance. In addition, queries are executed on the data source side and a load on the data source side accordingly increases.

The technology of Dremio Architecture Guide requires a data conversion process in Dremio, and consequently causes a drop in performance. In the case of a data source that is a DBMS, the process is executed on the data source side, and a load on the data source side accordingly increases.

In a case in which databases that are not designed with database integration in mind are integrated by copying with use of a virtual volume function of storage, different objects held in different databases sometimes have the same ID (file ID, table ID, or the like). In this case, it is required to identify which database an ID comes from.

U.S. Pat. No. 7,925,680 B1 deals with ID duplication by giving priority to a newer one. In JP 2015-146201 A, data is acquired via a tenant DBMS, and data conversion accordingly takes place each time data is acquired.

### SUMMARY OF THE INVENTION

An object of this invention is to integrate a plurality of databases in a manner that avoids conflicts.

An integration device according to one aspect of the invention disclosed in the present application includes a processor and a memory and being configured to hold communication to and from a plurality of devices, the processor being configured to execute a program, the memory being configured to store the program, the plurality of devices each including a database, wherein each of the plurality of devices includes a first table, a second table, and a third table, wherein the first table includes a DB name which is a name of the database, and storage location information about storage location of the database in the each of the plurality of devices, wherein the second table includes a schema name which is a name of a schema for managing one or more tables in the each of the plurality of devices, a table name or table names indicating a name or names of the one or more tables, and a DB area ID used to uniquely identify a DB area which is a storage area of a file in the database, wherein the third table includes the DB area ID and a relative file path of the file, and wherein the processor is configured to execute: mount processing in which a virtual volume is created for each database and mounted to the storage location information; first generation processing in which, from the first table of each of the plurality of devices, the DB name and the storage location information are acquired, the DB name is changed so as to differ from one database to another database, and a first integrated table is generated by associating a changed-to DB name and the storage location information with each other for each database; second generation processing in which, from the second table of each of the plurality of devices, the schema name, the table name, and the DB area ID are acquired, the schema name is changed so as to differ from one database to another database, and a second integrated table is generated by associating a changed-to schema name, the table name, the changed-to DB name, and the DB area ID with one another for each database; and third generation processing in which, from the third table of each of the plurality of devices, the DB area ID and the relative file path of the file are acquired, and a third integrated table is generated by associating the changed-to DB name, the DB area ID, and the relative file path with one another for each database.

According to the representative at least one embodiment of this invention, a plurality of databases can be integrated in a manner that avoids conflicts. Other objects, configurations, and effects than those described above are clarified by the following description of an embodiment.

### BRIEF DESCRIPTION OF THE DRAWINGS

FIG. 1 is a block diagram for illustrating a system configuration example 1 (on-premises 10) of the virtual integration system.

FIG. 2 is a block diagram for illustrating a system configuration example 2 (cloud 20) of the virtual integration system.

FIG. 3 is a block diagram for illustrating a system configuration example 3 (cloud 30) of the virtual integration system.

FIG. 4 is an explanatory diagram for illustrating an example of a data structure of the database volume.

FIG. 5 is an explanatory diagram for illustrating an example of embedding a DB area ID.

FIG. 6 is an explanatory diagram for illustrating an example of virtual DB integration.

FIG. 7 is an explanatory diagram for illustrating a table conversion example 1 about table conversion involved in virtual DB integration.

FIG. 8 is a flow chart for illustrating a virtual integration processing procedure example 1.

FIG. 9 is a flow chart for illustrating a query execution processing procedure example 1.

FIG. 10 is a flow chart for illustrating zero-copy processing.

FIG. 11 is an explanatory diagram for illustrating a table conversion example 2 about table conversion involved in virtual DB integration.

FIG. 12 is a flow chart for illustrating a virtual integration processing procedure example 2.

FIG. 13 is a flow chart for illustrating a query execution processing procedure example 2.

FIG. 14 is an explanatory diagram for illustrating a table conversion example 3 about table conversion involved in virtual DB integration.

### DETAILED DESCRIPTION OF THE PREFERRED EMBODIMENTS

### System Configuration Examples

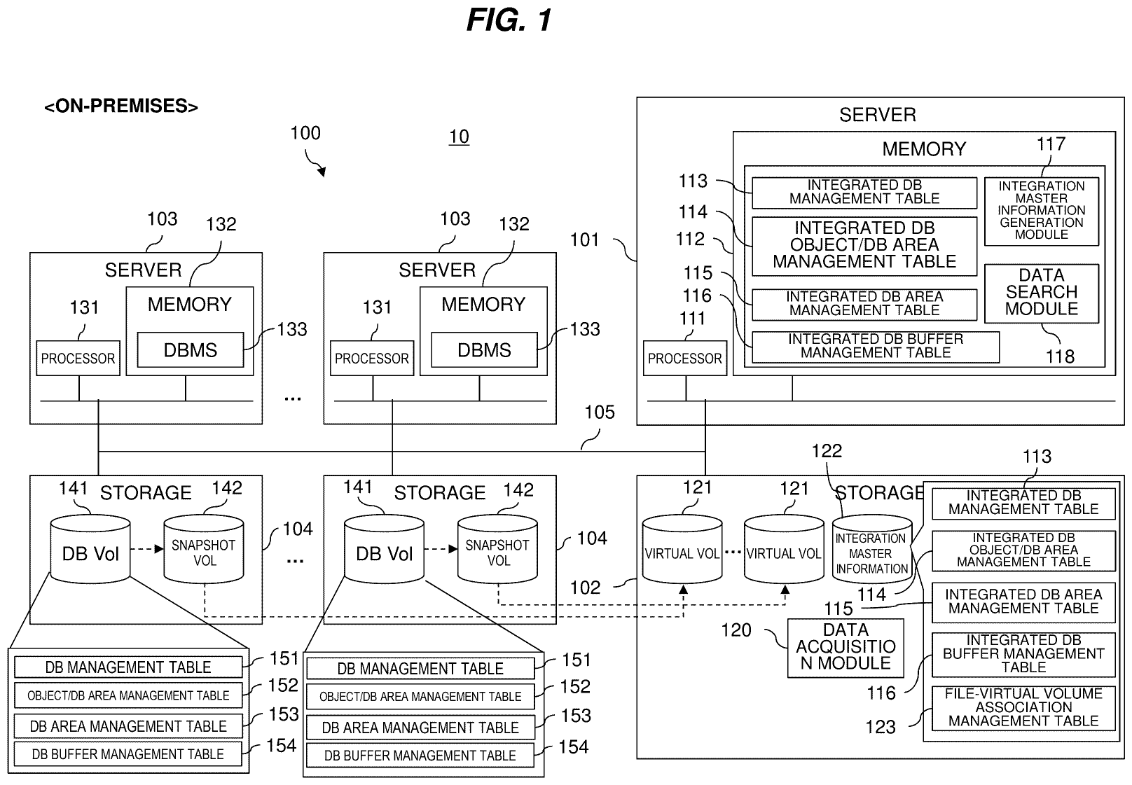

First, system configuration examples of a virtual integration system are described with reference to FIG. 1 to FIG. 3.

### FIG. 1: On-Premises Configuration

FIG. 1 is a block diagram for illustrating a system configuration example 1 (on-premises 10) of the virtual integration system. A virtual integration system 100 has an on-premises configuration including a first server 101, a first storage 102, second servers 103, and second storages 104. The first server 101, the first storage 102, the second servers 103, and the second storages 104 are coupled by a bus 105 in a manner that allows communication to and from one another.

The first server 101 includes a processor 111 and a memory 112. The processor 111 controls the first server 101. The memory 112 serves as a work area of the processor 111. The memory 112 is a non-transitory or transitory recording medium. The memory 112 stores an integrated DB management table 113, an integrated DB object/DB area management table 114, an integrated DB area management table 115, an integrated DB buffer management table 116, an integration master information generation module 117, and a data search module 118.

The integration master information generation module 117 is a program for causing the processor 111 to execute integration master generation processing. Through the integration master generation processing, the integrated DB management table 113, the integrated DB object/DB area management table 114, the integrated DB area management table 115, and the integrated DB buffer management table 116 are generated in the memory 112. The data search module 118 is a program for causing the processor 111 to execute data search processing.

The first storage 102 stores virtual volumes 121, integration master information 122, and a data acquisition module 120. The virtual volumes 121 store snapshots from the second storages 104. The integration master information 122 includes the integrated DB object/DB area management table 114, the integrated DB area management table 115, and the integrated DB buffer management table 116 which are generated on the first server 101. The integration master information 122 also includes a file-virtual volume association management table 123. The data acquisition module 120 is a program for causing the processor 111 or a processor (not shown) in the first storage 102 to acquire data from the second storages 104.

Each of the second servers 103 includes a processor 131 and a memory 132. The processor 131 controls the relevant second server 103. The memory 132 serves as a work area of the processor 131. The memory 132 is a non-transitory or transitory recording medium. The memory 132 stores a database management system (DBMS) 133. The DBMS 133 is a program for causing the processor 131 to execute management of a database in a database volume 141, and operation of the database that fulfills a request from external software.

Each of the second storages 104 stores the database volume 141 and a snapshot volume 142. The database volume 141 stores files. The database volume 141 also stores a DB management table 151, an object/DB area management table 152, a DB area management table 153, and a DB buffer management table 154. The snapshot volume 142 stores a snapshot which is a copy of a database. The snapshot is generated by the DBMS 133.

The virtual integration system 100 builds, in a short time, a cross-search environment for searching across databases at bases having the second servers 103 and the second storages 104, to thereby keep down effects of analysis execution on business operations at the bases.

The second server 103 and the second storage 104 are deployed for each base. In a case in which the virtual integration system 100 is implemented for, for example, a manufacturer, a base is a manufacturing factory. The second storage 104 at each base stores a manufacturing DB having the same data structure in the database volume 141. In a case in which the virtual integration system 100 is implemented for, for example, a medical care facility, a base is a hospital or a nursing-care facility. The database volume 141 of the second storage 104 of a hospital stores a medical receipt DB, and the second storage 104 of a nursing-care facility stores a nursing-care DB having a data structure different from a data structure of the medical receipt DB.

In any of the cases described above, the virtual integration system 100 is capable of virtual integration of databases across bases. In the following description, a sentence having a program as its subject indicates that the processor 111 or 131, or a device with the processor 111 or 131 installed therein, is executing a program implementing a function of a module of interest.

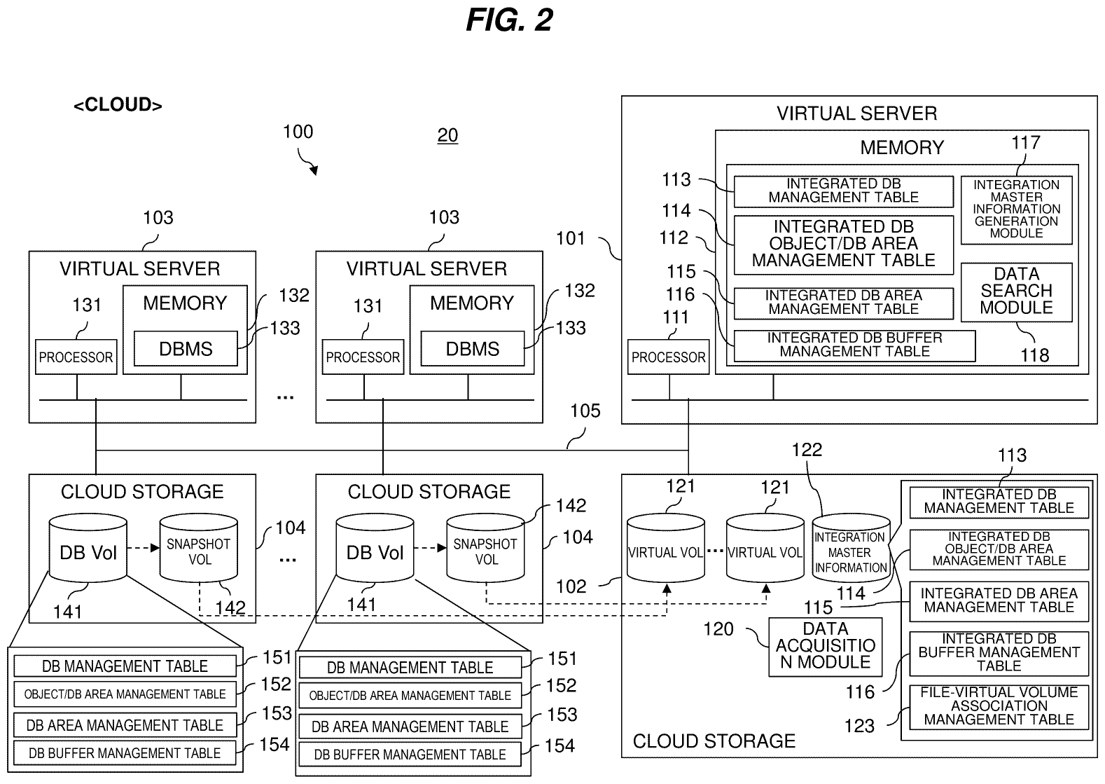

### FIG. 2: Cloud Configuration 1

FIG. 2 is a block diagram for illustrating a system configuration example 2 (cloud 20) of the virtual integration system 100. A cloud configuration 1 is a configuration example in which the virtual integration system 100 is implemented on cloud. Accordingly, the first server 101 and the second servers 103 are built as virtual servers on a cloud system 200. The first storage 102 and the second storages 104 are built as cloud storages on the cloud system 200.

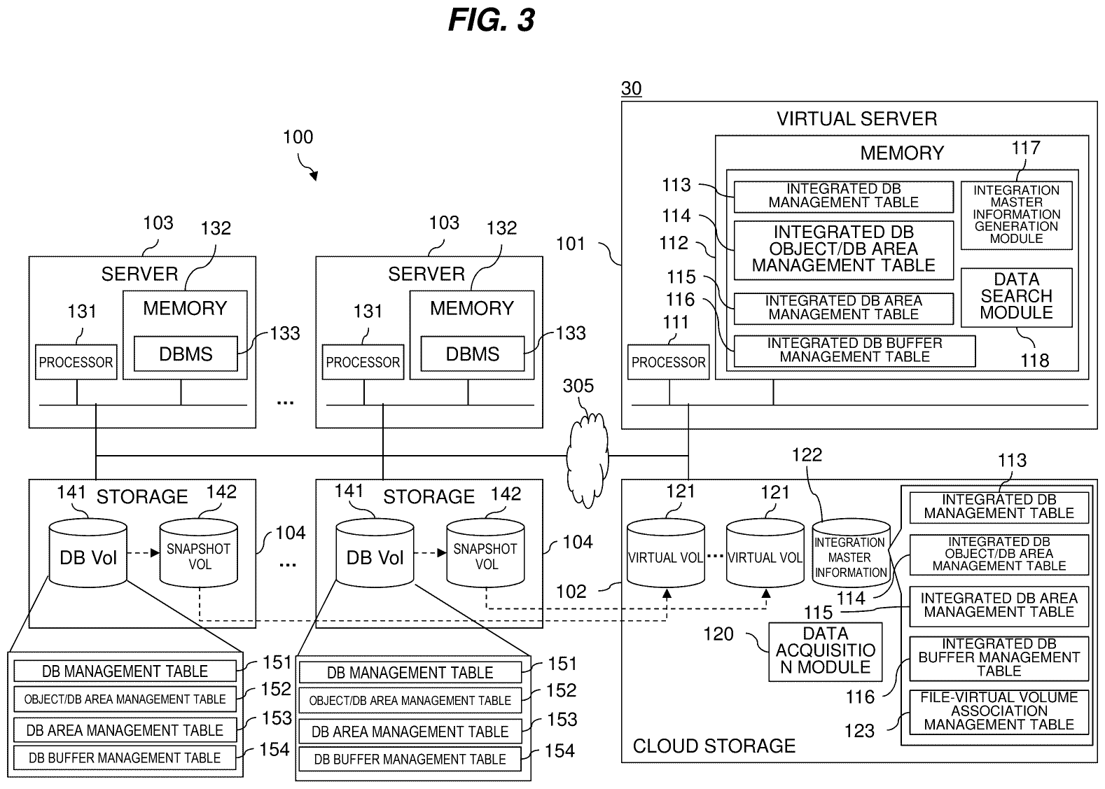

### FIG. 3: Cloud Configuration 2

FIG. 3 is a block diagram for illustrating a system configuration example 3 (cloud 30) of the virtual integration system 100. A cloud configuration 2 is a configuration example in which the first server 101 and the first storage 102 out of components of the virtual integration system 100 are implemented on the cloud 30. Accordingly, the first server 101 and the first storage 102 are coupled to the second servers 103 and the second storages 104 by a network 305, which is the Internet, a local area network (LAN), a wide area network (WAN), or the like, in a manner that allows communication to and from each other.

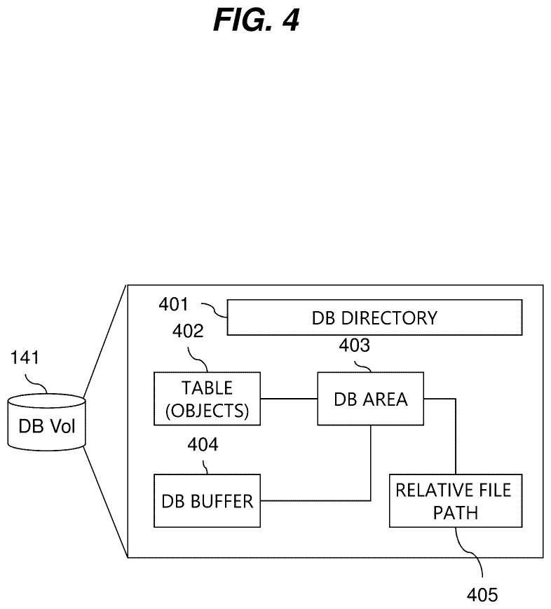

### FIG. 4: Data Structure of Database Volume 141

FIG. 4 is an explanatory diagram for illustrating an example of a data structure of the database volume 141. The database volume 141 has, as the data structure, a DB directory 401, a table (objects) 402, a DB area 403, a DB buffer 404, and a relative file path 405.

The DB directory 401 is information indicating a storage location of a database in the database volume 141. The table (objects) 402 is a table of a relational database, and stores data acquired at the base (for example, data detected by a sensor set in equipment of a factory, or diagnosis information of a patient). The DB area 403 is configured from one or more files. The DB buffer 404 is a buffer area in which a file in the DB area 403 is temporarily held. The relative file path 405 is information indicating a storage location of a file in the DB area 403. The DB directory 401 and the relative file path 405 are combined to form an absolute path.

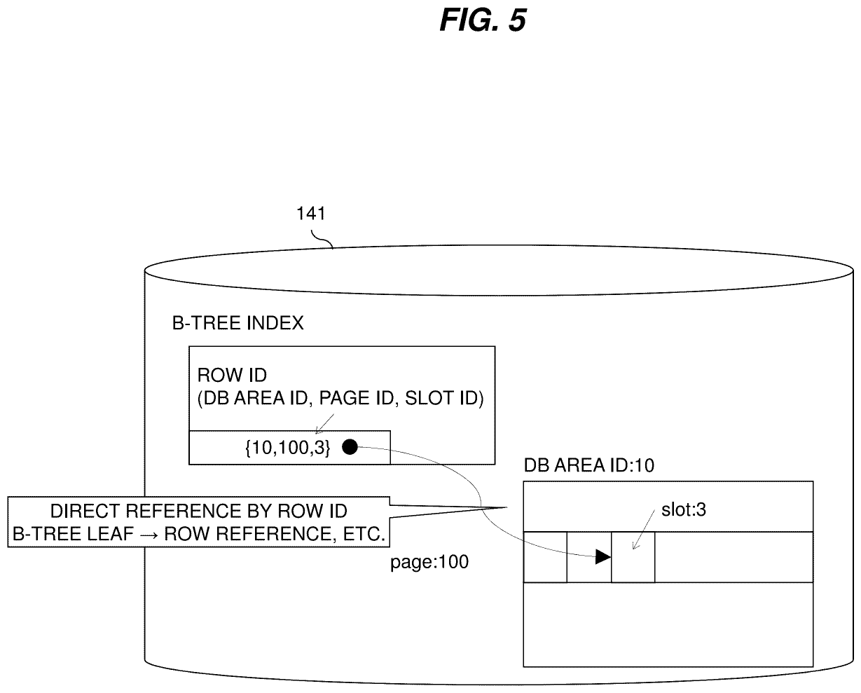

### FIG. 5: Embedding of DB Area ID

FIG. 5 is an explanatory diagram for illustrating an example of embedding a DB area ID. Description given here takes a B-tree index as an example. The DB area ID is identification information by which the DB area 403 is uniquely identified. The DB area ID is embedded as a row ID, along with a page ID and a slot ID. An example of the row ID given here is {10, 100, 3}. The DB area ID, the page ID, and the slot ID are each an identification number in ascending order that starts from 1. The DB area ID is “10,” the page ID is “100,” and the slot ID is “3.” A slot having a slot ID “3” and located on a page of a page ID “100” in the DB area 403 that is identified with a DB area ID “10” through reference by the row ID can be accessed.

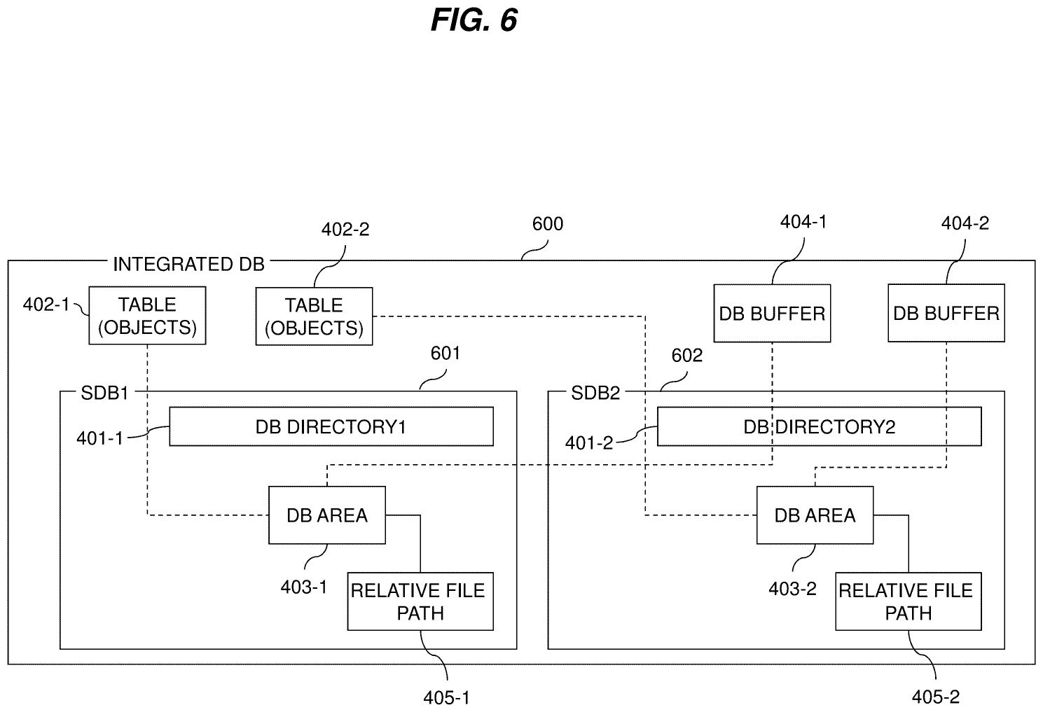

### FIG. 6: Virtual DB Integration

FIG. 6 is an explanatory diagram for illustrating an example of virtual DB integration. In FIG. 6, an example of integrating a pair of the second server 103 and the database volume 141 of the second storage 104 with another pair of the second server 103 and the database volume 141 of the second storage 104 is illustrated as an example. Sub-numbers are added here to the reference symbols of the components of FIG. 4 in order to discriminate pieces of the same component of FIG. 4 from one another.

An integrated DB 600 is generated in the first storage 102. The integrated

DB 600 includes a sub-DB 601 and a sub-DB 602. The sub-DB 601 includes a DB directory 401-1, a DB area 403-1, and a relative file path 405-1. The sub-DB 602 includes a DB directory 401-2, a DB area 403-2, and a relative file path 405-2. Tables (objects) 402-1 and 402-2 and the DB buffers 404-1 and 404-2 are placed outside the sub-DB 601 and the sub-DB 602.

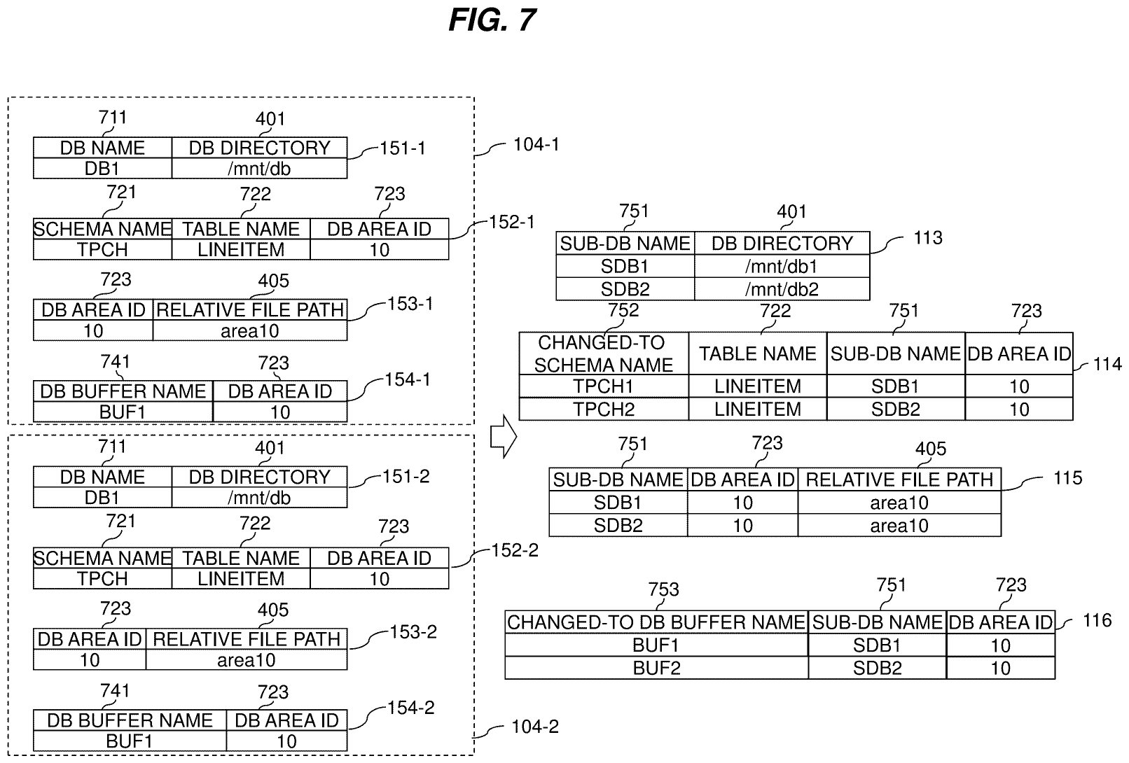

### FIG. 7: Table Conversion Example 1

FIG. 7 is an explanatory diagram for illustrating a table conversion example 1 about table conversion involved in virtual DB integration. In FIG. 7, an example of integrating a pair of the second server 103 and the database volume 141 of the second storage 104 with another pair of the second server 103 and the database volume 141 of the second storage 104 is illustrated as an example. In FIG. 7, sub-numbers are added to the reference symbols of the tables in the second storages 104 of FIG. 1 in order to discriminate one table from another, but are omitted from the description when the tables are not discriminated from each other.

In order to discriminate one pair of the second server 103 and the database volume 141 and the like of the second storage 104 from another pair of the second server 103 and the database volume 141 and the like of the second storage 104 in FIG. 1, the second servers are denoted by 103-1 and 103-2 and the second storages are denoted by 104-1 and 104-2 with sub-numbers added as in FIG. 7.

### DB Management Table 151

The DB management table 151 is a table for managing the database in the database volume 141, and includes, as fields, a DB name 711 and the DB directory 401. The DB name 711 is a name of the database. To give a specific example, “DB1” which is the DB name 711 in the DB management table 151-1 is the name of the database in the second storage 104-1, and “DB1” which is the DB name 711 in the DB management table 151-2 is the name of the database in the second storage 104-2.

### Object/DB Area Management Table 152

The object/DB area management table 152 is a table for managing the table (objects) 402 and the DB area 403, and includes, as fields, a schema name 721, a table name 722, and a DB area ID 723. The schema name 721 is a name of a group of one or more tables (objects) to which the table (objects) 402 belongs. The table name 722 is a name of the table (objects) 402. The DB area ID 723 is identification information by which the DB area 403 is uniquely identified.

### DB Area Management Table 153

The DB area management table 153 is a table for managing the DB area, and includes, as fields, a DB area ID 723 and the relative file path 405.

### DB Buffer Management Table 154

The DB buffer management table 154 is a table for managing the DB buffer 404, and includes, as fields, a DB buffer name 741 and a DB area ID 723. The DB buffer name 741 is a name of the DB buffer 404.

In the example of FIG. 7, the DB management tables 151-1 and 151-2 share the same data structure and the same values in the respective fields with each other, and this applies to the object/DB area management tables 152-1 and 152-2, the DB area management tables 153-1 and 153-2, and the DB buffer management tables 154-1 and 154-2. Accordingly, it is required in virtual integration to discriminate the same two tables from each other.

### Integrated DB Management Table 113

The integrated DB management table 113 is a table in which the DB management tables 151-1 and 151-2 are integrated by virtual integration. The integrated DB management table 113 includes, as fields, a sub-DB name 751 and the DB directory 401. The sub-DB name is a name of a sub-DB. In the example of FIG. 7, “SDB1” is the sub-DB name 751 of the sub-DB 601, and “SDB2” is the sub-DB name 751 of the sub-DB 602.

In the integrated DB management table 113, the sub-DB name 751 is set in order to discriminate one value of the DB name 711 from another value of the DB name 711. The value “SDB1” is the name of the sub-DB 601, and corresponds to “DB1” which is the DB name 711 in the DB management table 151-1. The value “SDB2” is the name of the sub-DB 602, and corresponds to “DB1” which is the DB name 711 in the DB management table 151-2.

In the integrated DB management table 113, in order to discriminate the DB directory 401 of the sub-DB 601 and the DB directory 401 of the sub-DB 602 from each other, the value of the DB directory 401 of the sub-DB 601 is changed from a value “/mnt/db” of the DB directory 401 in the DB management table 151-1 to “mnt/db1.” The value “/mnt/db1” specifies a virtual volume 121-1, which is one of the virtual volumes 121 that corresponds to a database volume 141-1 of the second storage 104-1.

Similarly, the value of the DB directory 401 of the sub-DB 602 is changed from a value “/mnt/db” of the DB directory 401 in the DB management table 151-2 to “mnt/db2.” The value “/mnt/db2” specifies a virtual volume 121-2, which is one of the virtual volumes 121 that corresponds to a database volume 141-2 of the second storage 104-2 storing the DB management table 151-2.

### Integrated DB Object/DB Area Management Table 114

The integrated DB object/DB area management table 114 is a table in which the object/DB area management tables 152-1 and 152-2 are integrated by virtual integration. The integrated DB object/DB area management table 114 includes, as fields, a changed-to schema name 752, the table name 722, the sub-DB name 751, and the DB area ID 723. The changed-to schema name 752 is a name to which the schema name 721 is changed.

In the integrated DB object/DB area management table 114, in order to discriminate one value of the schema name 721 from another value of the schema name 721, a value “TPCH” of the schema name 721 in the object/DB area management table 152-1 is changed to a value “TPCH1” of the changed-to schema name 752. Similarly, the value “TPCH” of the schema name 721 in the object/DB area management table 152-2 is changed to a value “TPCH2” of the changed-to schema name 752.

Including the sub-DB name 751, the integrated DB object/DB area management table 114 does not use discrimination based on the object/DB area management table 152 with respect to the table name 722 and the DB area ID 723 which are discriminable by sub-DB.

### Integrated DB Area Management Table 115

The integrated DB area management table 115 includes, as fields, the sub-DB name 751, the DB area ID 723, and the relative file path 405.

### Integrated DB Buffer Management Table 116

The integrated DB buffer management table 116 includes, as fields, a changed-to DB buffer name 753, the sub-DB name 751, and the DB area ID 723. The changed-to DB buffer name 753 is a name to which the DB buffer name 741 is changed. In the integrated DB buffer management table 116, in order to discriminate one value of the changed-to buffer name 753 from another value of the changed-to DB buffer name 753, a value “BUF1” of the DB area ID 723 in the DB buffer management table 154-1 is “BUF1” as the changed-to DB buffer name 753, and the value “BUF1” of the DB area ID 723 in the DB buffer management table 154-2 is changed to “BUF2” as the changed-to DB buffer name 753.

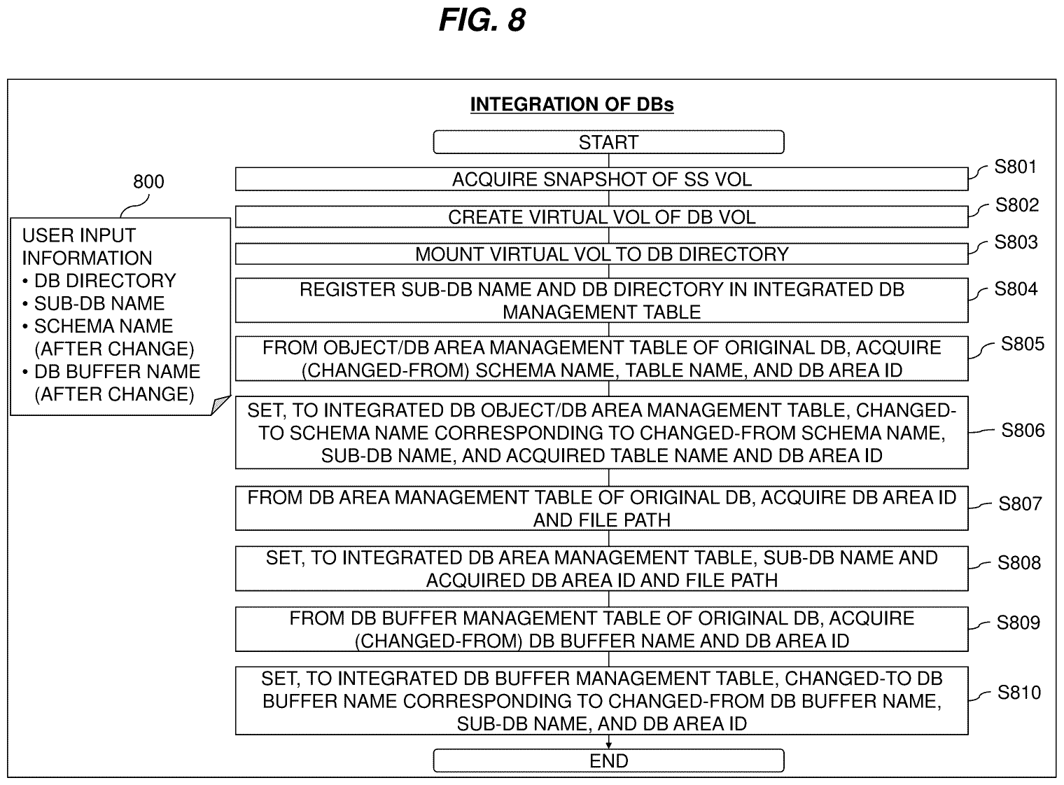

### FIG. 8: Integration Master Information Generation Processing 1

FIG. 8 is a flow chart for illustrating a virtual integration processing procedure example 1. The integration master information 122 is the integrated DB management table 113, the integrated DB object/DB area management table 114, the integrated DB area management table 115, and the integrated DB buffer management table 116.

Assumption here is that values of the DB directory 401 (/mnt/db1 and/mnt/db2), the sub-DB name 751 (SDB1 and SDB2), the changed-to schema name 752 (TPCH1 and TPCH2), and the changed-to DB buffer name 753 (BUF1 and BUF2) are specified as user input information 800.

### Step S801

The data acquisition module 120 acquires a snapshot of each snapshot volume 142.

### Step S802

The integration master information generation module 117 creates a virtual volume 121 for a database volume associated with the snapshot volume 142 from which the snapshot has been acquired. The integration master information generation module 117 also assigns a file descriptor to the virtual volume 121. The integration master information generation module 117 sequentially assigns file descriptors in ascending order that start from 1 to the virtual volumes 121.

### Step S803

The integration master information generation module 117 mounts the virtual volumes 121 to DB directories specified as the DB directory 401 in the user input information 800. To give a specific example, the integration master information generation module 117 mounts the virtual volume 121-1 to the DB directory 401 (/mnt/db1), and mounts the virtual volume 121-2 to the DB directory 401 (/mnt/db2). The integration master information generation module 117 associates a file descriptor 910 acquired in Step S802 with a virtual volume name 1001 that is a name of the virtual volume 121, to thereby generate the file-virtual volume association management table 123.

### Step S804

The integration master information generation module 117 registers the values of the sub-DB name 751 (SDB1 and SDB2) and the DB directory 401 (/mnt/db1 and/mnt/db2) in the integrated DB management table 113. The integrated DB management table 113 is generated in the integration master information 122 in this manner.

### Step S805

The integration master information generation module 117 acquires, from the object/DB area management tables 152-1 and 152-2 of the database volumes 141-1 and 141-2, the schema name 721 (TPCH) before the change, the table name 722 (LINEITEM), and the DB area ID 723 (10).

### Step S806

The integration master information generation module 117 sets, to the integrated DB object/DB area management table 114, values of the changed-to schema name 752 (TPCH1 and TPCH2) that correspond to the schema name 721 (TPCH) before the change and the sub-DB name 751 (SDB1 and SDB2), as well as the table name 722 (LINEITEM) and the DB area ID 723 (10) acquired in Step S805. The integrated DB object/DB area management table 114 is generated in the integration master information 122 in this manner.

### Step S807

The integration master information generation module 117 acquires, from the DB area management tables 153-1 and 153-2 of the database volumes 141-1 and 141-2, the DB area ID 723 (10) and the relative file path (area10).

### Step S808

The integration master information generation module 117 sets, to the integrated DB area management table 115, values of the sub-DB name 751, as well as the DB area ID 723 (10) and the relative file path (area10) acquired in Step S807.

The integrated DB area management table 115 is generated in the integration master information 122 in this manner.

### Step S809

The integration master information generation module 117 acquires, from the DB buffer management tables 154-1 and 154-2 of the database volumes 141-1 and 141-2, the DB buffer name 741 before the change and the DB area ID 723.

### Step S810

The integration master information generation module 117 sets, to the integrated DB buffer management table 116, values of the changed-to DB buffer name 753 (BUF1 and BUF2) associated with values of the DB buffer name 741 (BUF1 and BUF1) before the change, the sub-DB name 751 (SDB1 and SDB2), and the DB area ID (10). The integrated DB buffer management table 116 is generated in the integration master information 122 in this manner.

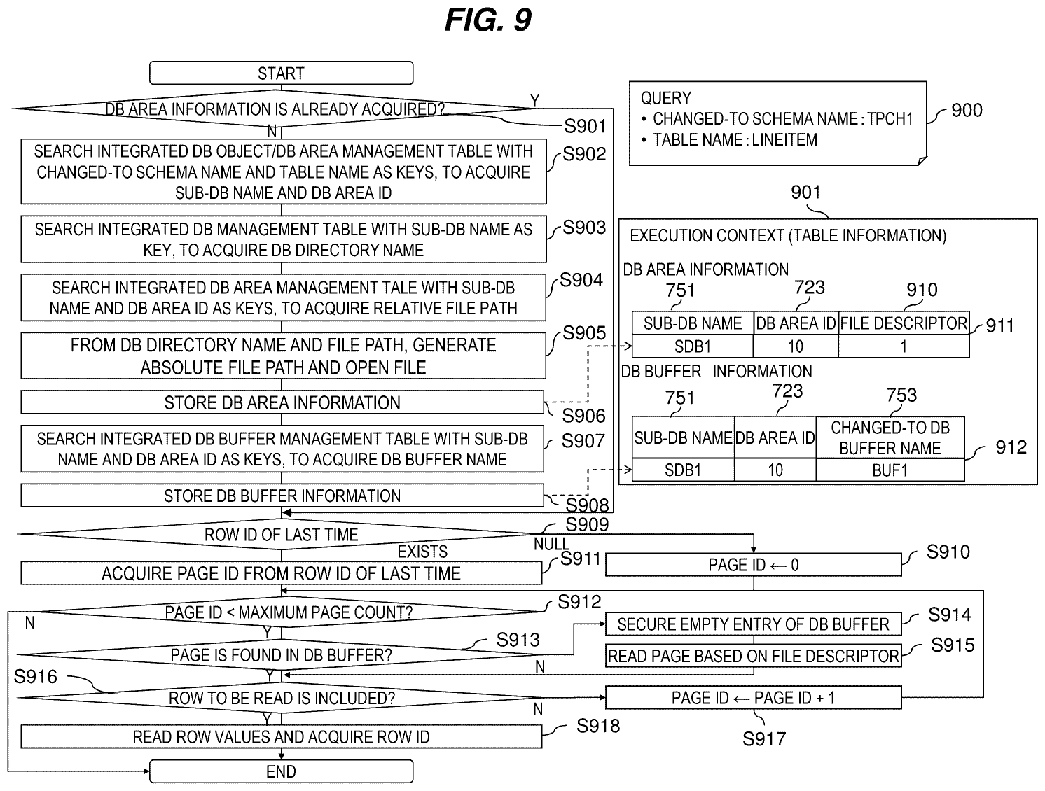

### FIG. 9: Query Execution Processing

FIG. 9 is a flow chart for illustrating a query execution processing procedure example 1. It is assumed that the changed-to schema name 752 (here, “TPCH1” as an example) and the table name 722 (LINEITEM) are given as a query 900.

### Step S901

The data search module 118 determines whether DB area information is already acquired. In a case of a first time, the DB area information has not been acquired (Step S901: No), and the process accordingly proceeds to Step S902 in which the data search module 118 executes name resolution (sub-DB resolution). When the DB area information is already acquired (Step S901: Yes), re-execution of name resolution (sub-DB resolution) is not required, and the process accordingly proceeds to Step S909.

### Step S902

The data search module 118 searches the integrated DB object/DB area management table 114 with the changed-to schema name 752 (TPCH1) and the table name 722 (LINEITEM) as keys, to acquire the sub-DB name 751 and the DB area ID 723. In a case of this example, “SDB1” and “10” are acquired as the sub-DB name 751 and the DB area ID 723, respectively.

### Step S903

The data search module 118 searches the integrated DB management table 113 with the sub-DB name 751 acquired in Step S902 as a key, to acquire the DB directory 401. In the case of this example, the sub-DB name 751 is “SDB1” and, accordingly, “/mnt/db1” is acquired as the DB directory 401.

### Step S904

The data search module 118 searches the integrated DB area management table 115 with the sub-DB name 751 and the DB area ID 723 as keys, to acquire the relative file path 405. In the case of this example, “area10” is acquired as the relative file path 405.

### Step S905

The data search module 118 combines the DB directory 401 and the relative file path 405 to generate an absolute file path, and opens a file specified by the absolute file path. In the case of this example, the DB directory 401 is “/mnt/db1” and the relative file path 405 is “area10,” and an absolute file path “/mnt/db1/area10” is accordingly generated.

### Step S906

The data search module 118 stores DB area information 911 in an execution context 901. In the case of this example, by the opening of the file in Step S905, “1” is acquired from the file as the file descriptor 910. The file descriptor 910 is identification information by which a file is uniquely identified. The data search module 118 stores a piece of DB area information 911 that associates “SDB1” which is the sub-DB name 751, “10” which is the DB area ID 723, and “1” which is the file descriptor 910 with one another.

### Step S907

The data search module 118 searches the integrated DB buffer management table 116 with the sub-DB name 751 and the DB area ID 723 as keys, to acquire the changed-to DB buffer name 753. In the case of this example, the sub-DB name 751 is “SDB1” and the DB area ID 723 is “10,” and “BUF1” is accordingly acquired as the changed-to buffer name 753.

### Step S908

The data search module 118 stores DB buffer information 912. The DB buffer information 912 is information associating the sub-DB name 751, the DB area ID 723, and the changed-to DB buffer name 753 that is acquired in Step S907 with one another. In the case of this example, “SDB1” which is the sub-DB name 751, “10” which is the DB area ID 723, and “BUF1” which is the changed-to DB buffer name 753 are stored in the DB buffer information 912 in association with one another.

Through the processing steps of Step S902 to Step S908, the name resolution (sub-DB resolution) is completed.

### Step S909

The data search module 118 determines whether there is a row ID of a last time. When the row ID of the last time has been kept (Step S909: Yes), the process proceeds to Step S911. When the row ID of the last time has not been kept (Step S909: No), the process proceeds to Step S910. In a case of a first time (of executing name resolution), the process proceeds to Step S910.

### Step S910

The data search module 118 sets the page ID to “0,” and the process proceeds to Step S912.

### Step S911

The data search module 118 acquires the page ID from the row ID of the last time. For example, when the row ID of the last time is {10, 100, 3} as illustrated in FIG. 5, the data search module 118 acquires “100” as the page ID. The process then proceeds to Step S912.

### Step S912

The data search module 118 determines whether “page ID <maximum page count” is satisfied. When “page ID<maximum page count” is satisfied (Step S912: Yes), the process proceeds to Step S913. When “page ID<maximum page count” is not satisfied (Step S912: No), the query execution is ended.

### Step S913

The data search module 118 determines whether a page identified by the page ID is cached in the DB buffer 404 prescribed in the DB buffer information 912. In the case of this example, whether the page is cached in BUF1 is determined. When the page is cached (Step S913: Yes), the process proceeds to Step S916. When the page is not cached (Step S913: No), the process proceeds to Step S914.

### Step S914

The data search module 118 secures an empty entry of the DB buffer 404, and the process proceeds to Step S915. In the case of this example, an empty entry is secured in BUF1.

### Step S915

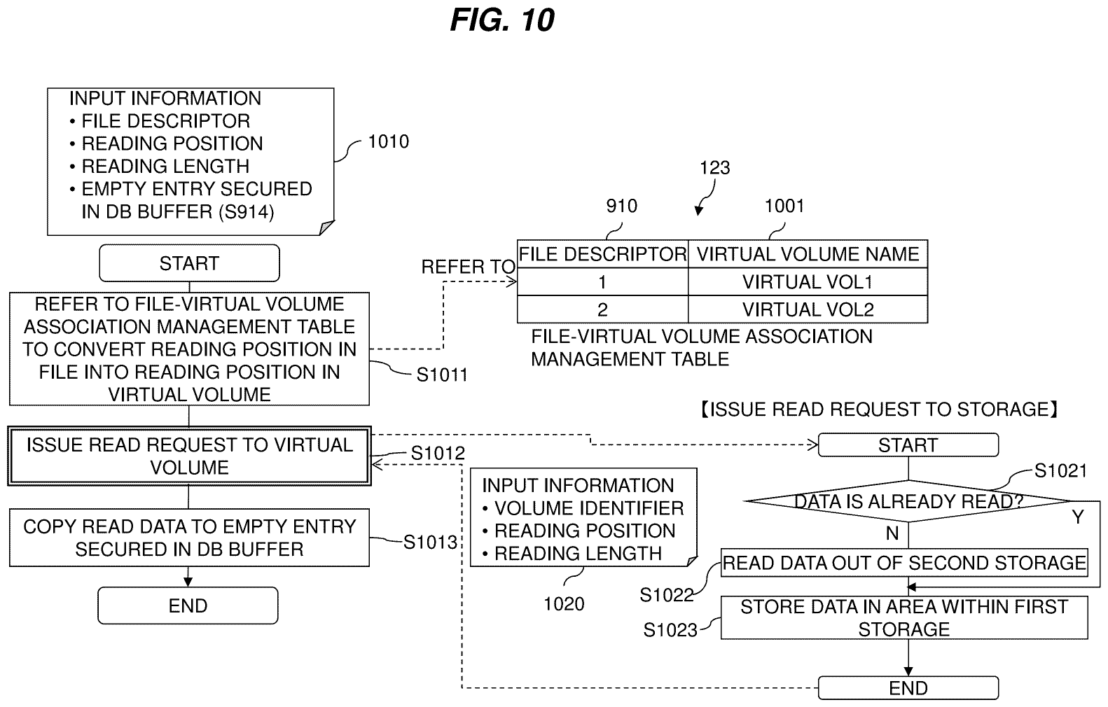

The data search module 118 identifies the sub-DB name 751 and the DB area ID 723 that are associated with the file descriptor 910 of the DB area information 911. In the case of this example, the sub-DB name 751 is “SDB1” and corresponds to the sub-DB 601. The DB area ID 723 is “10.” Accordingly, the data search module 118 accesses the file in the DB area 403-1 which has “10” as the DB area ID 723 in the sub-DB 601. With databases thus discriminated from one another by sub-DB name, conflicts of the DB area ID 723 are avoided without changing the DB area ID 723, and the right file can be accessed. The data search module 118 then reads, out of the file, the page identified by the page ID. The read page is stored in the empty entry of the DB buffer 404 secured in Step S914. This read processing is zero-copy processing. The zero-copy processing is described later with reference to FIG. 10.

### Step S916

The data search module 118 determines whether there is a row to be read in the read page. The row to be read is a row having the row ID of the last time in the case in which the row ID of the last time is found in Step S909, and is a head row of the page in a case in which the row ID of the last time is not found in Step S909. When there is the row to be read, the process proceeds to Step S918. When there is no row to be read, the process proceeds to Step S917.

### Step S917

With no row to be read on the read page, the data search module 118 increments the page ID, and the process returns to Step S912.

### Step S918

With the read page having the row to be read, the data search module 118 reads values of the row to be read, acquires a row ID of the read row, and ends the processing. The acquired row ID serves as the row ID of the last time in Step S909.

### FIG. 10: Zero-Copy Processing

FIG. 10 is a flow chart for illustrating zero-copy processing. The zero-copy processing is the processing executed in Step S915 of FIG. 9, and is processing of copying a snapshot in the snapshot volume 142 of one of the second storages 104 to one of the virtual volumes 121 of the first storage 102. The zero-copy processing is executed by the data search module 118 and the data acquisition module 120.

The data search module 118 reads, based on input information 1010, out of the file identified by the file descriptor 910, the page identified by the page ID. A specific description is given below. The input information 1010 includes the file descriptor 910, a reading position, and a reading length.

In the zero-copy processing, the file-virtual volume association management table 123 is referred to. The file-virtual volume association management table 123 includes the file descriptor 910 and a virtual volume name 1001.

### Step S1011

The data search module 118 refers to the file-virtual volume association management table 123, and converts a reading position in the file identified by the file descriptor 910 into a reading position in one of the virtual volumes 121. To give a specific example, when a file descriptor “1,” a reading position “100,” and a reading length “30” are given as the input information 1010, because files and the virtual volumes 121 are associated with each other on a one-to-one basis, the data search module 118 identifies “virtual Vol 1” as the virtual volume name 1001 associated with the file descriptor “1.” The reading position “100” and the reading length “10” are used as they are.

### Step S1012

The data search module 118 issues a read request to one of the virtual volumes 121 that is identified by the conversion of Step S1011. The read request includes “virtual Vol 1” as the virtual volume name 1001, the reading position “100,” and the reading length “10.”

### Step S1013

The data search module 118 copies read data to the empty entry of the DB buffer 404 secured in Step S914.

### Step S1021

The data acquisition module 120 acquires input information 1020 from the data search module 118, and determines whether data has been read in response to the read request of Step S1012. The input information 1020 is the “virtual volume name, reading position, and reading length” included in the read request.

To give a specific example, the data acquisition module 120 keeps a list of already read “virtual volume name, reading position, and reading length” in the first storage 102, compares the “virtual volume name, reading position, and reading length” included in the read request to the list, and determines that a range specified by the reading position and the reading length in a virtual volume specified by the read request is already read when the included “virtual volume name, reading position, and reading length” is on the list. When the data is already read (Step S1021: Yes), the process proceeds to Step S1023. When the data has not been read (Step S1021: No), the process proceeds to Step S1022.

### Step S1022

The data acquisition module 120 reads the data out of the snapshot volume 142 of the second storage 104.

### Step S1023

The data acquisition module 120 copies the data found in Step S1021 to have already been read, or the data read in Step S1022, to an area prepared in the first storage 102 by the data acquisition module 120. In Step S1013, the data search module 118 copies the data read here to the empty entry of the DB buffer 404 secured in Step S914.

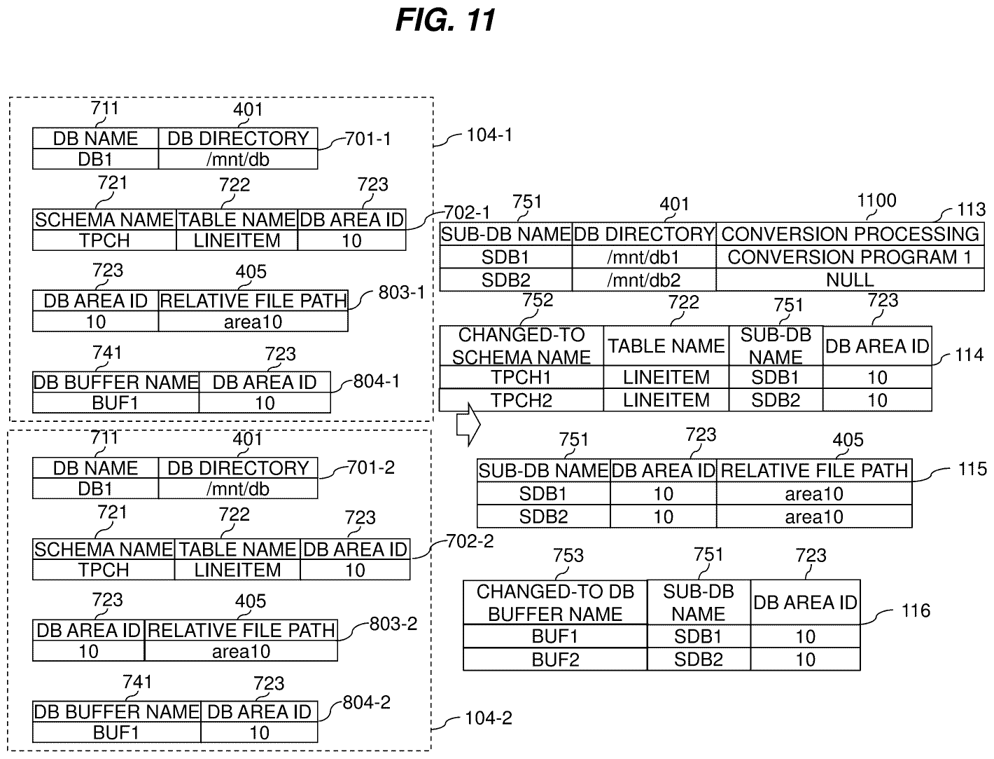

### FIG. 11: Table Conversion Example 2

FIG. 11 is an explanatory diagram for illustrating a table conversion example 2 about table conversion involved in virtual DB integration. In FIG. 11, an example of table conversion for a case in which the second storage 104-1 and the second storage 104-2 have different database formats is illustrated. Differences from FIG. 7 are described.

### Integrated DB Management Table 113

The integrated DB management table 113 includes, as fields, conversion processing 1100 in addition to the sub-DB name 751 and the DB directory 401. The conversion processing 1100 prescribes a program for converting a database format. In a case in which a conversion program is registered in the conversion processing 1100 of the integrated DB management table 113, the first server 101 applies the conversion program.

In the example of FIG. 11, “Conversion Program 1” is prescribed in the conversion processing 1100 in the entry of SDB1, and “NULL” is set, that is, no conversion program is prescribed, in the conversion processing 1100 in the entry of SDB2. A conversion program is a program for converting a database format. To give a specific example, “Conversion Program 1” is a program for converting the database format of the second storage 104-1 into the database format of the second storage 104-2.

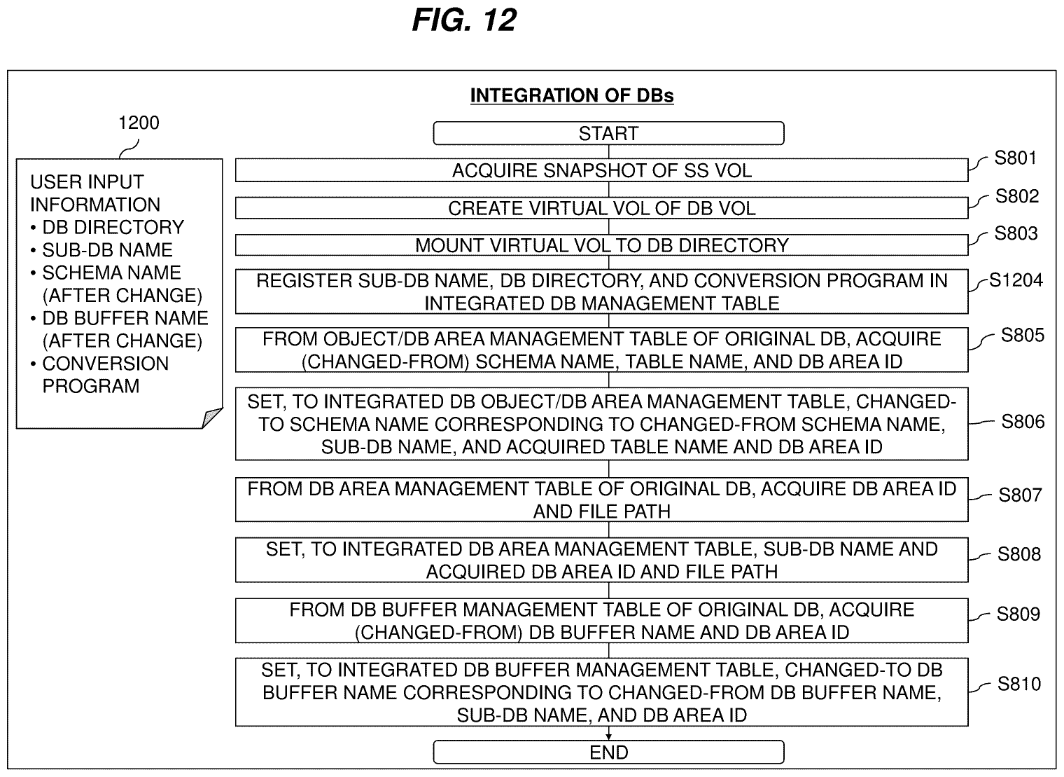

### FIG. 12: Integration Master Information Generation Processing 2

FIG. 12 is a flow chart for illustrating a virtual integration processing procedure example 2. FIG. 12 is an illustration of processing of generating the integration master information 122 by the table conversion of FIG. 11. Differences from FIG. 8 are described. User input information 1200 is information obtained by adding the conversion program to the user input information 800.

### Step S1204

The integration master information generation module 117 registers the values of the sub-DB name 751 (SDB1 and SDB2), the DB directory 401 (/mnt/db1 and/mnt/db2), and the conversion program in the integrated DB management table 113. The integrated DB management table 113 is generated in the integration master information 122 in this manner.

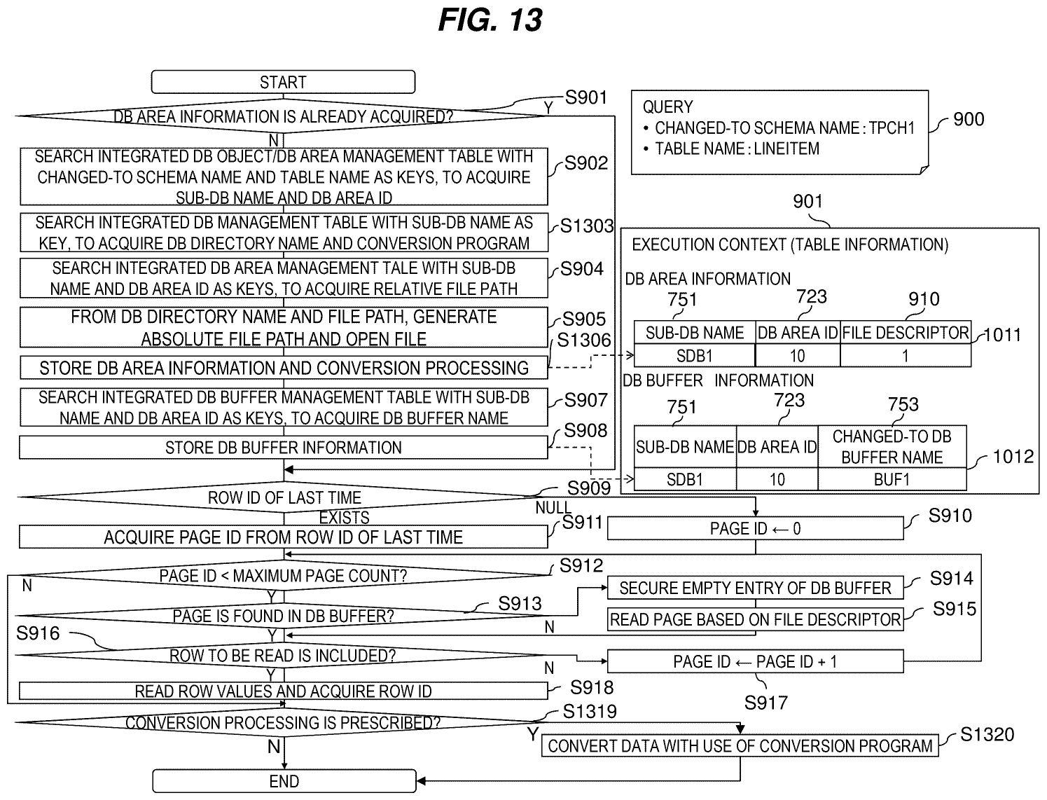

### FIG. 13: Query Execution Processing

FIG. 13 is a flow chart for illustrating a query execution processing procedure example 2. Differences from FIG. 9 are described.

### Step S1303

The data search module 118 searches the integrated DB management table 113 with the sub-DB name 751 acquired in Step S902 as a key, to acquire the DB directory 401 and the conversion processing 1100. In the case of this example, the sub-DB name 751 is “SDB1” and, accordingly, “/mnt/db1” is acquired as the DB directory 401, and “a conversion program” is acquired as the conversion processing 1100.

### Step S1306

The data search module 118 stores the DB area information 911 and the conversion processing 1100 in the execution context 901. In the case of this example, by the opening of the file in Step S905, “1” is acquired from the file as the file descriptor 910. The file descriptor 910 is identification information by which a file is uniquely identified. The data search module 118 stores a piece of DB area information 911 that associates “SDB1” which is the sub-DB name 751, “10” which is the DB area ID 723, and “1” which is the file descriptor 910 with one another.

### Step S1319

The data search module 118 determines whether the conversion processing 1100 is included in the execution context 901. When the conversion processing 1100 is included (Step S1319: Yes), the process proceeds to Step S1320. When the conversion processing 1100 is not included (Step S1319: No), the query execution is ended.

### Step S1320

The data search module 118 converts the data (values of the row read in Step S918) with use of the conversion program acquired as the conversion processing 1100.

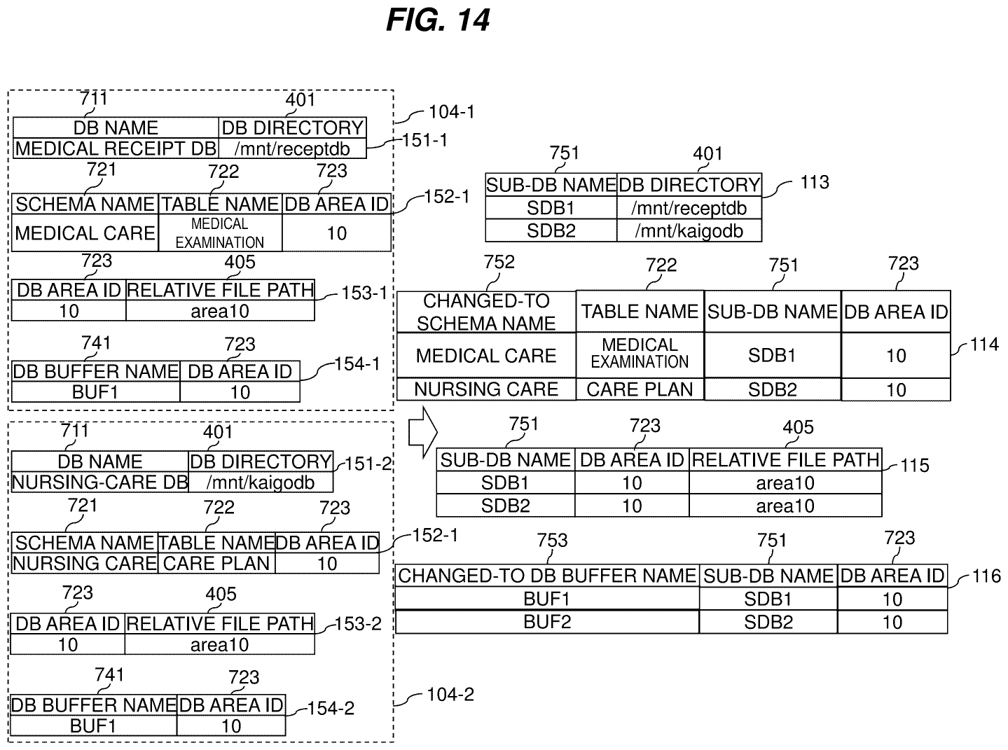

### FIG. 14: Table Conversion Example 3

FIG. 14 is an explanatory diagram for illustrating a table conversion example 3 about table conversion involved in virtual DB integration. In FIG. 14, an example of conversion among different databases is illustrated. Differences from FIG. 7 are described.

### DB Management Table 151

In the DB management table 151-1, the DB name 711 is “medical receipt DB” and the DB directory 401 is “/mnt/receptdb.” Meanwhile, in the DB management table 151-2, the DB name 711 is “nursing-care DB” and the DB directory 401 is “/mnt/kaigodb.”

### Object/DB Area Management Table 152

In the object/DB area management table 152-1, the schema name 721 is “medical care,” the table name 722 is “medical examination,” and the DB area ID 723 is “10.” Meanwhile, in the object/DB area management table 152-2, the schema name 721 is “nursing care,” the table name 722 is “care plan,” and the DB area ID 723 is “10.”

### Integrated DB Management Table 113

In the integrated DB management table 113, the receipt DB is given “SDB1” as the sub-DB name 751, and has “/mnt/receptdb” registered as the DB directory 401 thereof, whereas the nursing-care DB is given “SDB2” as the sub-DB name 751, and has “/mnt/kaigodb” registered as the DB directory 401 thereof.

### Integrated DB Object/DB Area Management Table 114

In the integrated DB object/DB area management table 114, the changed-to schema name 752 and the table name 722 that are associated with the value “SDB1” of the sub-DB name 751 are “medical care” and “medical examination,” respectively, and the changed-to schema name 752 and the table name 722 that are associated with the value “SDB2” of the sub-DB name 751 are “nursing care” and “care plan,” respectively. Virtual integration of different databases is thus executable.

According to the at least one embodiment of this invention, a plurality of databases can thus be integrated in a manner that avoids conflicts of the DB area ID 723.

Although the present disclosure has been described with reference to example embodiments, those skilled in the art will recognize that various changes and modifications may be made in form and detail without departing from the spirit and scope of the claimed subject matter. For example, the above-mentioned embodiments are described in detail for a better understanding of this disclosure, and this disclosure is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. An integration device, comprising a processor and a memory and being configured to hold communication to and from a plurality of devices, the processor being configured to execute a program, the memory being configured to store the program, the plurality of devices each including a database,
wherein each of the plurality of devices includes a first table, a second table, and a third table,
wherein the first table includes a DB name which is a name of the database, and storage location information about storage location of the database in the each of the plurality of devices,
wherein the second table includes a schema name which is a name of a schema for managing one or more tables in the each of the plurality of devices, a table name or table names indicating a name or names of the one or more tables, and a DB area ID used to uniquely identify a DB area which is a storage area of a file in the database,
wherein the third table includes the DB area ID and a relative file path of the file, and
wherein the processor is configured to execute:
mount processing in which a virtual volume is created for each database and mounted to the storage location information;
first generation processing in which, from the first table of each of the plurality of devices, the DB name and the storage location information are acquired, the DB name is changed so as to differ from one database to another database, and a first integrated table is generated by associating a changed-to DB name and the storage location information with each other for each database;
second generation processing in which, from the second table of each of the plurality of devices, the schema name, the table name, and the DB area ID are acquired, the schema name is changed so as to differ from one database to another database, and a second integrated table is generated by associating a changed-to schema name, the table name, the changed-to DB name, and the DB area ID with one another for each database; and
third generation processing in which, from the third table of each of the plurality of devices, the DB area ID and the relative file path of the file are acquired, and a third integrated table is generated by associating the changed-to DB name, the DB area ID, and the relative file path with one another for each database.

2. The integration device according to claim 1, wherein the integration device is configured to execute:
input processing in which input of a query including the changed-to schema name and the table name is received;
first acquisition processing in which, based on the query input in the input processing, the second integrated table is searched in order to acquire the changed-to DB name and the DB area ID;
second acquisition processing in which, based on the changed-to DB name acquired through the first acquisition processing, the first integrated table is searched in order to acquire the storage location information;
third acquisition processing in which, based on the changed-to DB name and the DB area ID that are acquired through the first acquisition processing, the third integrated table is searched in order to acquire the relative file path;
opening processing in which, based on the storage location information acquired through the second acquisition processing and the relative file path acquired through the third acquisition processing, an absolute file path is generated, and a specific file specified by the absolute file path is opened;
fifth generation processing in which, by associating the changed-to DB name, the DB area ID, and a file descriptor of the specific file opened through the opening processing with one another, DB area information is generated; and
search processing in which, based on the DB area information generated through the fifth generation processing, a search for the specific file is executed on the DB area identified by the DB area ID in the virtual volume associated with the database that is identified by the changed-to DB name.

3. The integration device according to claim 2,
wherein the processor is configured to execute determination processing for determining whether the DB area information is already generated, and
wherein, when it is determined in the determination processing that the DB area information is yet to be generated, the processor is configured to execute the first acquisition processing, the second acquisition processing, the third acquisition processing, the opening processing, and the fifth generation processing, and, when it is determined in the determination processing that the DB area information is already generated, the processor is configured to avoid executing the first acquisition processing, the second acquisition processing, the third acquisition processing, the opening processing, and the fifth generation processing.

4. The integration device according to claim 2,
wherein, in the first generation processing, the processor is configured to generate the first integrated table from the first table of each of the plurality of devices by associating, for each database, the changed-to DB name, the storage location information, and conversion processing in which a conversion program for converting data is prescribable, with one another, and
wherein, in the search processing, in a case in which the conversion program is prescribed with respect to the changed-to DB name, the processor is configured to convert data in the specific file with use of the conversion program.

5. The integration device according to claim 1,
wherein a fourth table including a DB buffer name and the DB area ID is included, the DB buffer name being a name of a DB buffer which serves as a buffer area for the DB area, and
wherein the processor is configured to execute fourth generation processing in which, from the fourth table of each of the plurality of devices, the DB buffer name and the DB area ID are acquired, the DB buffer name is changed so as to differ from one database to another database, and a fourth integrated table is generated by associating the changed-to buffer name, the table name, the changed-to DB name, and the DB area ID with one another for each database.

6. The integration device according to claim 2,
wherein a fourth table including a DB buffer name and the DB area ID is included, the DB buffer name being a name of a DB buffer which serves as a buffer area for the DB area, and
wherein the processor is configured to execute:
fourth generation processing in which, from the fourth table of each of the plurality of devices, the DB buffer name and the DB area ID are acquired, the DB buffer name is changed so as to differ from one database to another database, and a fourth integrated table is generated by associating the changed-to buffer name, the table name, the changed-to DB name, and the DB area ID with one another for each database;
fourth acquisition processing in which, based on the changed-to DB name and the DB area ID, the fourth integrated table is searched in order to acquire the changed-to DB buffer name; and
sixth generation processing in which DB buffer information is generated by associating the changed-to DB name, the DB area ID, and the changed-to DB buffer name with one another.

7. An integration method to be executed by an integration device that includes a processor configured to execute a program and a memory configured to store the program, and that is configured to hold communication to and from a plurality of devices each including a database,
each of the plurality of devices including a first table, a second table, and a third table,
the first table including a DB name which is a name of the database, and storage location information about storage location of the database in the each of the plurality of devices,
the second table including a schema name which is a name of a schema for managing one or more tables in the each of the plurality of devices, a table name or table names indicating a name or names of the each or more tables, and a DB area ID used to uniquely identify a DB area which is a storage area of a file in the database,
the third table including the DB area ID and a relative file path of the file,
the integration method comprising executing, by the processor:
mount processing in which a virtual volume is created for each database and mounted to the storage location information;
first generation processing in which, from the first table of each of the plurality of devices, the DB name and the storage location information are acquired, the DB name is changed so as to differ from one database to another database, and a first integrated table is generated by associating a changed-to DB name and the storage location information with each other for each database;
second generation processing in which, from the second table of each of the plurality of devices, the schema name, the table name, and the DB area ID are acquired, the schema name is changed so as to differ from one database to another database, and a second integrated table is generated by associating a changed-to schema name, the table name, the changed-to DB name, and the DB area ID with one another for each database; and
third generation processing in which, from the third table of each of the plurality of devices, the DB area ID and the relative file path of the file are acquired, and a third integrated table is generated by associating the changed-to DB name, the DB area ID, and the relative file path with one another for each database.

8. A non-transitory computer-readable recording medium having recorded thereon an integration program for causing a processor to execute an integration processing of integrating databases included in a plurality of devices,
each of the plurality of devices including a first table, a second table, and a third table,
the first table including a DB name which is a name of the database, and storage location information about storage location of the database in the each of the plurality of devices,
the second table including a schema name which is a name of a schema for managing one or more tables in the each of the plurality of devices, a table name or table names indicating a name or names of the each or more tables, and a DB area ID used to uniquely identify a DB area which is a storage area of a file in the database,
the third table including the DB area ID and a relative file path of the file,
the integration program causing the processor to execute:
mount processing in which a virtual volume is created for each database and mounted to the storage location information;
first generation processing in which, from the first table of each of the plurality of devices, the DB name and the storage location information are acquired, the DB name is changed so as to differ from one database to another database, and a first integrated table is generated by associating a changed-to DB name and the storage location information with each other for each database;
second generation processing in which, from the second table of each of the plurality of devices, the schema name, the table name, and the DB area ID are acquired, the schema name is changed so as to differ from one database to another database, and a second integrated table is generated by associating a changed-to schema name, the table name, the changed-to DB name, and the DB area ID with one another for each database; and
third generation processing in which, from the third table of each of the plurality of devices, the DB area ID and the relative file path of the file are acquired, and a third integrated table is generated by associating the changed-to DB name, the DB area ID, and the relative file path with one another for each database.
